(19) United States
(12) Patent Application Publication
(10) Pub. No.: US 2008/0046497 A1
(43) Pub. Date: Feb. 21, 2008

(54) Systems and Methods for Implementing a Double Precision Arithmetic Memory Architecture

(75) Inventors: Yue-Peng Zheng, Marlboro, NJ (US); Ehud Langberg, Wayside, NJ (US); Wenye Yang, Morganville, NJ (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CONEXANT SYSTEMS, INC., Red Bank, NJ (US)

(21) Appl. No.: 11/840,547

(22) Filed: Aug. 17, 2007

Related U.S. Application Data
(60) Provisional application No. 60/838,435, filed on Aug. 18, 2006.

(51) Int. Cl. G06F 7/38; G06F 1/16

(52) U.S. Cl. 708/604; 708/109

(57) ABSTRACT

Systems and methods for a memory structure are described for increasing the throughput of double precision operations. Broadly, the present invention utilizes a novel memory system to process double precision data in a single memory access. In accordance with one embodiment, a method for increasing throughput of arithmetic operations on double precision data by reducing the number of memory accesses comprising: retrieving a double precision value from a memory, wherein the double precision value is comprised of a high word and a low word, wherein the double precision value is retrieved in a single memory access; selecting a word within the double precision value, wherein the portion selected is a single precision value; multiplying the word with a single precision operand to generate a single precision product; adding the product to a double precision operand to produce a double precision result; and forwarding the double precision result back to memory for storage.

### CROSS-REFERENCE TO RELATED APPLICATION

This application claims priority to, and the benefit of, U.S. Provisional Patent Application entitled, “DOUBLE PRECISION ARITHMETIC ARCHITECTURE,” having Ser. No. 60/838,435, filed on Aug. 18, 2006, which is incorporated by reference in its entirety.

### TECHNICAL FIELD

The present disclosure relates to double precision arithmetic memory architecture.

### BACKGROUND

Double precision operations are frequently employed in high performance digital signal processing tasks in telecommunication and other electronic systems, such as in digital subscriber line (xDSL) modems. At the circuit and electronic component level, the ability to perform double precision arithmetic operations has been relatively expensive to implement, particularly in low cost, low power applications, such as DSL modems and other electronic equipment. In a DSL modem, the onboard processing unit is generally used to perform double precision computations. The results of these computations may then be passed back to some type of filter adaptation circuitry for filter implementation. However, this technique requires significant control, timing synchronization and communication design, thereby greatly complicating the overall implementation. Therefore, a heretofore unaddressed need exists in the industry to address the aforementioned deficiencies and inadequacies.

### SUMMARY

Briefly described, one embodiment, among others, includes a memory structure for increasing the throughput of double precision arithmetic operations comprising: a memory configured to store double precision data, wherein the double precision data comprise high words and low words, a data router configured to retrieve at least one double precision value from memory such that the high word and the low word of the double precision value are retrieved simultaneously, the data router further configured to route the words to arithmetic operators, a multiplier configured to multiply one of said words by a single precision operand to produce a single precision product, an accumulator configured to add the single precision product to a double precision operand to produce a double precision result, and a register configured to temporarily store the double precision result from the accumulator, wherein the register may be accessed to retrieve the double precision result to undergo additional arithmetic operations, and wherein the register is configured to forward the double precision result back to memory for storage.

Another embodiment includes a method for increasing throughput of arithmetic operations on double precision data by reducing the number of memory accesses comprising: retrieving a double precision value from a memory, wherein the double precision value is comprised of a high word and a low word, wherein the double precision value is retrieved in a single memory access; selecting a word within the double precision value, wherein the portion selected is a single precision value; multiplying the word with a single precision operand to generate a single precision product; adding the product to a double precision operand to produce a double precision result; and forwarding the double precision result back to memory for storage.

Yet another embodiment includes a method for increasing throughput of arithmetic operations in an adaptive filtering algorithm comprising: retrieving a double precision filter coefficient from a memory, wherein the coefficient is comprised of a high word and a low word, wherein the double precision coefficient is retrieved in a single memory access; selecting among the high word portion, the low word portion, and a single precision error correction factor; multiplying the selection with a single precision data input to generate a single precision product; adding the single precision product to a double precision value to generate a new double precision filter coefficient; and forwarding the new coefficient back to memory for storage.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A illustrates the functional blocks for an embodiment of a memory structure.

FIG. 1B is a block diagram of an embodiment of the data router in FIG. 1A.

FIG. 2 illustrates the memory address alignment of double precision data according to embodiments of the memory structure.

FIG. 3 illustrates one embodiment of a memory structure for efficiently performing double precision operations in the context of adaptive filtering.

FIG. 4 is a flowchart for an embodiment of a method for performing double precision operations according to the memory structure described herein.

FIG. 5 is a flowchart for an embodiment of the memory structure used in an adaptive filter.

### DETAILED DESCRIPTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims.

In view of the perceived shortcomings of known systems and methods for implementing double precision arithmetic, various embodiments of the present invention provide a double precision memory structure that lowers costs of products in terms of silicon size, processing resources in terms of millions instructions per second (MIPS), and power consumption while maintaining the high fidelity of double precision computations. Thus, various embodiments described herein provide for a special memory structure that achieves the same throughput as single precision operations for double precision operations.

In the context of xDSL systems, various operations within xDSL systems require the multiplication of two single precision numbers and the summation of this product with a double precision number stored in memory. Generally, these double precision operations are performed using a DSL modem's onboard processing unit. Once the operation is performed, the result may be stored back into memory before being sent upstream back up to the CO. Exemplary embodiments of the memory structure provide for greater throughput with respect to double precision arithmetic operations to reduce the MIPS (million instructions per section) processing performance needed to perform computationally intensive double precision operations.

As is known, a single precision number generally occupies only one address location in memory and is defined by the memory width. A double precision number requires two memory address locations for storage. As a non-limiting example, in a memory structure providing 32 bit wide address locations, a double precision number is 64 bits long and is stored across two address locations. A double precision may further be defined to be a variety of types, including for example, integer types and floating point types. Floating point numbers, which take up two address locations, are typically stored according to the following format: the first bit is the sign bit, a second group of bits is the exponent, and the remaining bits are the significand or significant digits of the floating point number. Generally, systems use the IEEE 754 standard (incorporated herein by reference in its entirety) for encoding floating point numbers, for a single precision number, the sign bit is the 1 bit, the exponent field is 8 bits wide, and the significand field is 24 bits wide. Thus, the number 123.45 would be represented by the following: a positive sign bit, and exponent value of −2 and a significand of 12345.

The throughput for double precision operations is generally lower than for single precision operations as more memory accesses are needed to complete an operation. Various embodiments of the present invention employ a novel memory structure to achieve a higher throughput for double precision operations. Broadly, the present invention utilizes a novel memory structure to process double precision data in a single memory access.

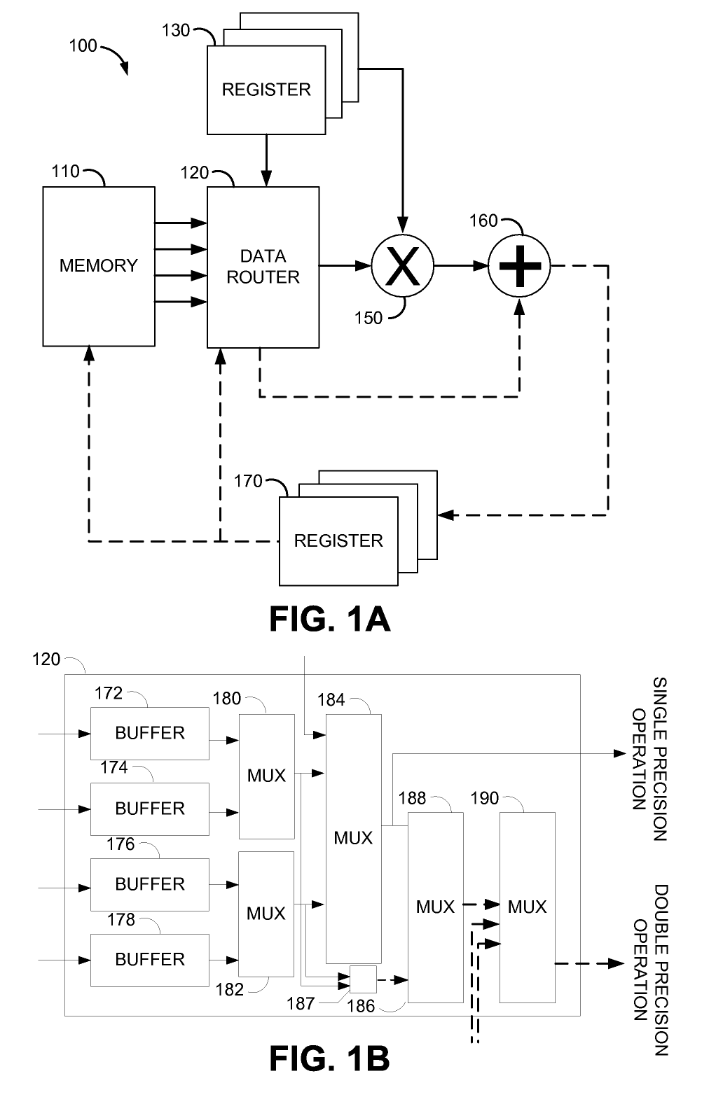

Reference is now made to FIG. 1A, which illustrates the functional blocks of an embodiment of a memory structure. One of ordinary skill in the art will appreciate that memory structures can, and typically will, comprise other components, which have been omitted for purposes of brevity. The memory structure 100 includes a memory 110 configured to store data. The memory 110 may be configured to store both single precision and double precision values. For some embodiments, double precision values are stored according to even-odd memory address locations and not according to odd-even memory address locations. As a non-limiting example, the following memory locations could be utilized to store a double precision value under the current memory storage scheme: memory address 0d (decimal) and memory address 1d. Likewise, a double precision value could also be stored at memory address 2d and memory address 3d such that the upper word of the double precision value is stored in even memory addresses. However, the following address allocations would not be valid for storing a double precision value under the current memory addressing scheme: address 1d and address 2d; and address 3d and address 0d. Under the current memory structure, the least significant bit (LSB) is not utilized due to the fact that a single precision number takes up half the memory space as a double precision number. Thus, for exemplary embodiments of the memory structure described herein, double precision numbers are aligned to even memory address locations.

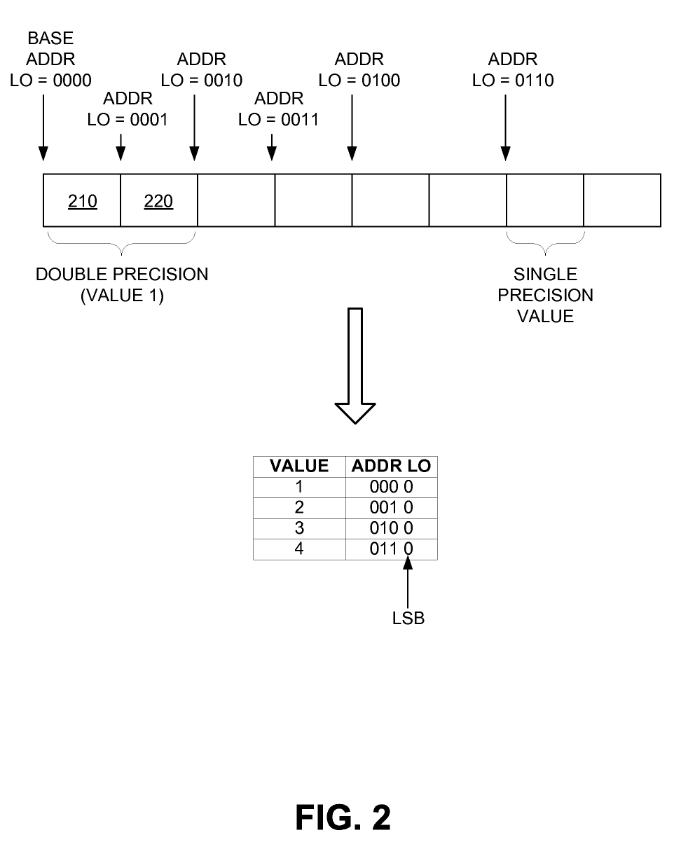

Reference is briefly made to FIG. 2, which illustrates the memory address alignment of double precision data according to embodiments of the memory structure. As described earlier, double precision values occupy two memory address locations 210, 220, while a single precision value only occupies one memory address location. For purposes of illustration, only the last four bits of the memory addresses (denoted as “Addr Lo”) are shown. The very first double precision value is stored at a base address of 0000, as depicted in FIG. 2. The next sequentially available memory address is at address 0010 (Addr Lo=0010). After that, the next sequentially available memory address is at Addr Lo=0100 and so on.

Referring back to FIG. 1A, the memory structure further comprises a data router 120, which retrieves double precision values from memory 110 in a single memory access. According to some embodiments, multiple double precision values may be retrieved from memory simultaneously. For instances where multiple double precision values are retrieved, the data router 120 may retrieve the double precision values on a word-by-word basis. Double precision values are generally comprised of a high word and a low word. A word generally refers to a fixed-sized unit defined by a pre-determined number of bits. As a non-limiting example, memory architectures may utilize a word size of 16, 32 or 64 bits. It should be emphasized that in the memory structure shown, both the low word and the high word of a given double precision value are retrieved at the same time rather than in separate memory accesses. This differs from various prior art approaches where the high word and low word of a double precision value are retrieved and processed separately, thereby requiring additional clock cycles and memory access to perform the same arithmetic operations.

Shown also in FIG. 1A are general purpose registers 130 used for quick access for processing by, for example, a central processing unit (CPU) or a digital signal processor (DSP). As appreciated by those skilled in the art, given the very quick access times for registers 130, 170, many memory architectures may perform arithmetic operations utilizing registers 130, 170 to temporarily store results before either moving the values back to memory or performing additional arithmetic operations. As a non-limiting example, general purpose registers 130, 170 may be used to simply store values to be used as operands in arithmetic operations. Finally, for some embodiments, the general purpose registers 130, 170 may be sized such that a single word can be stored in the register.

The memory structure 100 also includes a multiplier 150 which multiplies two operands to generate a product. As shown in FIG. 1A, one of the operands may be sent from the data router 120. In some embodiments, the data router 120 may forward either the high word or the low word of one of the double precision values retrieved from memory. Depending on which portion of the double precision number must undergo a multiplication operation, the corresponding word is selected and forwarded to the multiplier 150 via the data router 120. For exemplary embodiments, the multiplier 150 only performs single precision operations. That is, both operands are single precision, or single word values. A single precision multiplication operation produces a product where the bit width is the sum of the number of bits of both the multiplier and multiplicand. Therefore, a product resulting from a single precision multiplication operation is generally truncated when it is added to a single precision word. It should be noted that for exemplary embodiments of the double precision memory structure described herein, the resolution of the product from a single precision multiplication operation is fully maintained when it is added to a double precision word.

The multiplier 150 then forwards the single precision result to the next arithmetic operator, the accumulator 160. It should be emphasized that the accumulator 160 performs double precision operations. The data flow of double precision values is denoted by the dashed lines within FIG. 1A. In some instances, the data router 120 may forward the high words from two double precision values to the accumulator 160, which adds two operands. The accumulator 160 generates a double precision result and forwards the result to a general purpose register 170 for temporary storage. The value may either then be forwarded back to memory for storage or be temporarily stored in a general purpose register 170 for further processing. The general purpose register 170 may hold values from previous arithmetic operations and may be forwarded back to the selection 120 for iterative processing before finally being stored in memory 110.

Reference is now made to FIG. 1B, which is a block diagram of an embodiment of the data router in FIG. 1A. The data router 120 retrieves double precision data from memory 110 and routes the data to various locations within the memory structure data path to undergo arithmetic operations. Furthermore, utilization of the data router 120 provides flexibility in routing portions of double precision data on a word-by-word basis for arithmetic processing. As one non-limiting example, the data router 120 may route the low word of a double precision value to the multiplier 150 while routing both the high word and the low word of the double precision value to the accumulator 160.

To achieve flexibility in routing portions of double precision data on a word-by-word basis, the data router 120 may be comprised of a series of buffers 172, 174, 176, 178 which interface with the memory 110 to retrieve double precision data. In some embodiments, the buffers 172, 174, 176, 178 may be word-sized registers that retrieve double precision data on a word-by-word basis. As known by known those skilled in the art, registers may be implemented in a number of ways, including the use of flip-flops and high speed core memory. It should be noted that the data router 120 retrieves double precision data in one memory access by utilizing multiple buffers. At the same time, use of multiple word-sized buffers provide the flexibility of routing different portions of a double precision value to different locations within the memory structure.

The data router 120 may be further comprised of a network of interconnected multiplexers 180, 182, 184, 188, 190 which are each used to select from a plurality of sources and forward the output to either another location within the data router 120 or to a location external to the data router 120 such as the accumulator 160. Furthermore, as denoted by the dashed lines within FIG. 1B, the multiplexers may either accept single precision inputs, double precision inputs, or a combination of the two. Data router 120 may further comprise buffers 187 used to combine two words to form a double precision value. As illustrated in FIG. 1B, this double precision value may be forwarded to another multiplexer 180. The multiplexers may also accept data from general purpose registers 130, 170 described in FIG. 1A for routing. It should be noted that the interconnections shown in FIG. 1B reflect only one possible embodiment for the data router 120. It should be emphasized that depending on the particular application/algorithm, many variations and modifications may be made to embodiments of the data router 120 without substantially departing from the scope and spirit of the invention. The various components within the data router 120 may be controlled by a processing unit such as a DSP executing a particular set of instructions.

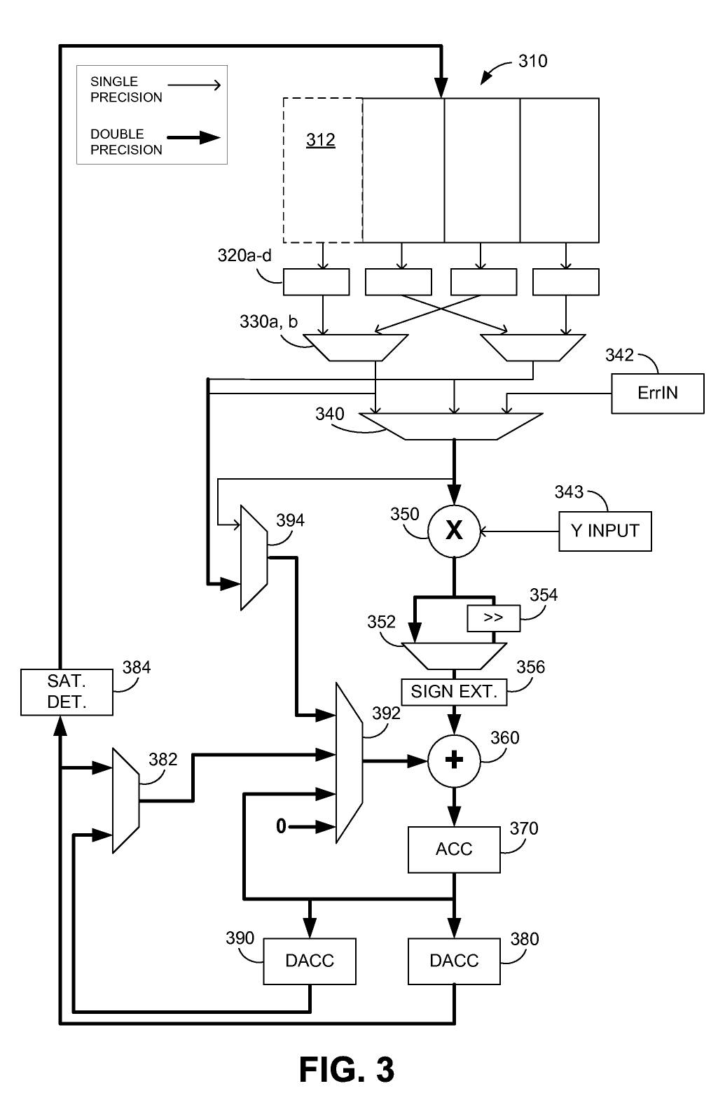

Reference is now made to FIG. 3, which illustrates an application of an embodiment of a memory structure for efficiently performing double precision operations in the context of an adaptive filter. Single precision and double precision arithmetic operations are performed on filter coefficients retrieved from memory. It should be emphasized that while embodiments of the memory structure are discussed as part of an adaptive filter for illustrative purposes, the memory structure described herein may be used in other applications as well. It should be emphasized that embodiments discussed herein may be implemented in (and/or associated with) one or more different devices. More specifically, depending on the particular configuration, the memory architecture described herein may be implemented in any xDSL modem, central office equipment, a tuner board, a set-top box, a satellite system, a television, a computing device (e.g., laptop, PDA), a cellular telephone, a wireless communication receiver, and/or other devices.

As known by those skilled in the art, adaptive filters are digital filters that perform digital signal processing and that modify or adapt the filter characteristics by adjusting filter coefficients based on an input signal. Generally, some type of optimizing algorithm may be utilized for adjusting the filter coefficients. For some implementations of adaptive filters, filter coefficients are utilized in a feedback configuration where the coefficients are adjusted in an iterative fashion until an optimum setting is achieved for the channel conditions that currently exist. As a simplified illustrative example, one set of filter coefficients may be utilized for line condition 1, whereas a different set of filer coefficients may be utilized for line condition 2 and so on. It should be noted that the actual derivation of coefficients and concept adaptive filtering may be performed in many ways and is outside the scope of this disclosure.

For the illustrative application in FIG. 3 involving an adaptive filter, the memory 310 may take the form of a coefficient random access memory (CRAM). The memory 310 stores coefficient values used for adaptive filtering. In the context of a DSL system, CPE (customer premise equipment such as a DSL modem) may perform local sampling of noise conditions on the channel, for example, and depending on the nature of the noise (e.g., continuous noise vs. impulse noise), the CPE may perform arithmetic operations to adjust filter coefficients accordingly and then forward the coefficients upstream to a CO to compensate for the noise conditions that currently exist between the CPE and the CO.

In FIG. 3, the memory 310 is subdivided into four address locations 332 for illustrative purposes. One skilled in the art will appreciate that the memory 330 may be partitioned into any number of address locations 312. For the adaptive filter shown, the data router 120 described in FIG. 1A may be comprised of a series of buffers 320a-d and multiplexers 330a-b, 340, 382, 392, 394 for routing data to different locations within the memory structure on a word-by-word basis. The series of buffers 320a-d retrieve double precision values (i.e., filter coefficients) from the memory 330 on a word-by-word basis. As described earlier, double precision values are generally comprised of a high word and a low word. Thus, for some embodiments, the buffers 320a-d may be word-sized. It should be further noted that the buffers 320a-d may be comprised of flip-flops and may function as shift registers as would be appreciated by one having ordinary skill in the art.

As shown in memory structure, word-sized buffers 320a-d simultaneously retrieve two double precision values from memory 330 for processing. It should be appreciated that both the high words and the low words of the double precision values are retrieved simultaneously rather than in separate in memory accesses, thereby reducing the number of cycles needed to complete the arithmetic operations discussed below. For some configurations, the low words of each double precision value are sent to multiplexer 330a, while the high words are sent to multiplexer 330b. Based on which portion of the double precision value is to undergo arithmetic operations, either the high word or the low word is forwarded to the next multiplexer 340.

The multiplexer 340 selects either the low word, the high word, or a parameter Errin 342 to forwarded to the arithmetic operators for processing. Parameter Errin 342 is a error correction factor used for adjusting the filter coefficients according to the line conditions present. Generally, the parameter Errin 342 reflects the amount of discrepancy from an expected value. In this context, the Errin parameter 342 reflects the difference between a Y input 343 (received value) and a reference value (expected value). While the derivation of Errin 342 is outside the scope of the present disclosure, one should note that the parameter Errin 342 is a single precision value.

The multiplier 350 shown in FIG. 3 is configured to receive single precision operands or inputs and generate a single precision product. The single precision value parameter Y Input 343 reflects data that has been sampled by the CPE and is used for adjusting filter coefficients. Due to interfering signals on the line between the CPE and CO such as noise and crosstalk, the received signal will generally be distorted to some degree, thereby necessitating the use of parameter Errin 342.

The single precision product of the multiplier 350 is forwarded to the shift operator 354 stage. The shift operator 354 performs a weighting of the adjusted filter coefficient at the output of the single precision multiplier 350. For instances in which noise is present for only a very short duration (e.g., impulse noise), it is generally not desirable to make a significant adjustment to the coefficient data since the duration of the impulse noise is so short (even if the magnitude of the noise if very high). In contrast, the ongoing presence of noise would be given a higher weighting. The shift operator 354 performs a bit-wise shift operation to provide the proper weighting for the current operand being passed into the accumulator 360.

Next, the filter coefficient passes through a sign extension block 356 where the number of bits of the filter coefficient is increased while preserving the filter coefficient's sign (i.e., positive or negative). This step is necessary if a bit-wise shift right operation was performed in the previous stage. Sign extension is performed by appending bits to the most significant side of the number and is dependent on the particular signed number representation used. For some embodiments of the adaptive filter, two's complement notation is utilized.

In the next stage, the accumulator 360 receives the sign extended operand from the shift operator 354 and receives a double precision value from selector 392. The accumulator 360 is configured to perform double precision operations. It should be further noted that the selector 392 may be part of the data router 120 described in FIG. 1A. As shown in FIG. 3, a number of values may be sent to the accumulator 360. For example a value of zero may be sent to the accumulator 360 if the feedback loop shown in FIG. 3 determines that no further adjustment needs to be made to the other operand of the accumulator 360. On the other hand, a value from a prior arithmetic operation may be looped around and sent to the accumulator 360 for iterative processing. This may be accomplished through a series of temporary buffers 370, 380, 390. These buffers 370, 380, 390 are general purpose registers known by those skilled in the art and are used to temporarily store different coefficient values for processing. Registers 370, 380, 390 are used for computational purposes in the event that multiple iterations are needed to process a given filter coefficient. Register 370 may store one coefficient value while register 380 may store another coefficient value derived from a prior iteration. Finally, register 390 may store yet another coefficient value.

Saturation detector 384 monitors coefficient data before it is stored back in memory 310 to ensure that the value does not exceed the maximum value allowed such that an overflow occurs. As a non-limiting example, for a memory structure supporting 16 bit single precision data (and 32 bit double precision data), the saturation detector 384 monitors the double precision data coming from register 380. If the data stored exceeds the range of values allowed for a 32 bit value, the saturation detector 384 rounds down the value before it is forwarded to memory 330 for storage. It should be emphasized that depending on the particular adaptive filtering technique used, many variations and modifications may be made to the embodiment shown in FIG. 3. For example, techniques for adaptive adjustment of filter coefficients may include, but is not limited to, the following: Recursive Least Squares (RLS), Weighted Recursive Least Squares (WRLS), Least Mean Squares (LMS), Normalized Least Mean Squares (NLMS), and Kalman filtering.

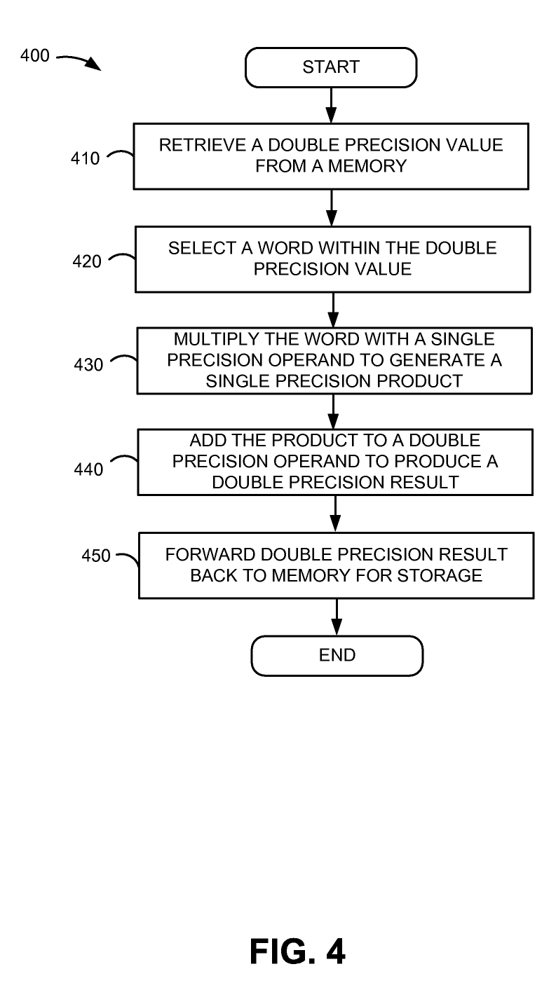

Reference is made to FIG. 4, which is a flowchart for an embodiment of a method for performing double precision operations according to the memory structure described herein. Beginning with block 410, a double precision value is retrieved from a memory, wherein the double precision value is comprised of a high word and a low word. Next, in block 420, a word is selected within the double precision value, wherein the portion selected is a single precision value. In block 430, the word that was selected in block 420 is multiplied with a single precision operand to generate a single precision product. This single precision product is added with a double precision operand to produce a double precision result (block 440). Finally, in block 450, the double precision result is forwarded back to memory for storage.

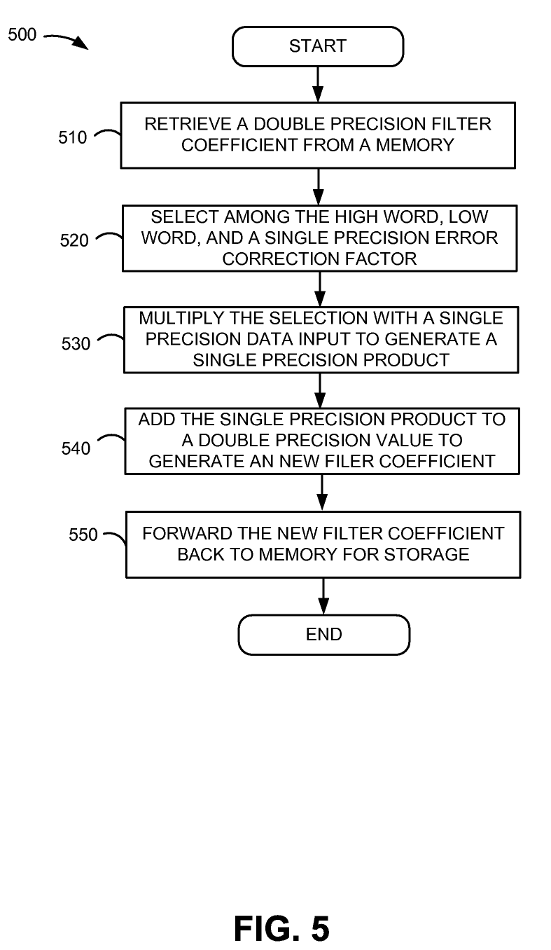

FIG. 5 is a flowchart for an embodiment of the memory structure used in an adaptive filter. Beginning with block 510, a double precision coefficient is retrieved from a memory, wherein the coefficient is comprised of a high word and a low word. Next, in block 520, a selection is made from among the following: high word portion, the low word portion, and a single precision error correction factor. In block 530, a single precision y input is multiplied with the selection to generate a single precision product. Next, in block 540, the double precision value is added to the product to generate an adjusted double precision filter coefficient. Finally, in block 550, the adjusted coefficient is forwarded back to the memory for storage.

It should be noted that according to the embodiments described herein, double precision operations are performed such that the same throughput as single precision numbers is achieved. Furthermore, it should further be appreciate that this reduction in throughput is achieved without the need to reduce MIPS count for double precision operations. Finally, it should be appreciated that the power consumption typically required for double precision numbers is decreased due to the decreased throughput.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims. Therefore, the embodiments of the present inventions are not to be limited in scope by the specific embodiments described herein. For example, although many of the embodiments disclosed herein have been described in the context of a novel memory double precision memory structure with particular use for xDSL modems, other embodiments, in addition to those described herein, will be apparent to those of ordinary skill in the art from the foregoing description and accompanying drawings. Further, although some of the embodiments of the present invention have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Many modifications to the embodiments described above can be made without departing from the spirit and scope of the invention.

At least the following is claimed:

1. A memory system for increasing the throughput of double precision arithmetic operations comprising:
a memory configured to store double precision data, wherein the double precision data comprises high words and low words;
a data router configured to retrieve at least one double precision value from memory such that the high word and the low word of the double precision value are retrieved simultaneously, the data router further configured to route the words to arithmetic operators;
a multiplier configured to multiply one of the words by a single precision operand to produce a single precision product;
an accumulator configured to add the single precision product to a double precision operand to produce a double precision result; and
a register configured to temporarily store the double precision result from the accumulator, wherein the register may be accessed to retrieve the double precision result to undergo additional arithmetic operations, and wherein the register is configured to forward the double precision result back to the memory for storage.

2. The system of claim 1, wherein the data router comprises a plurality of buffers and a plurality of multiplexers, wherein the size of each buffer is one word.

3. The system of claim 1, wherein the data router is further configured to receive and route both single precision and double precision data from sources external to the memory.

4. The system of claim 1, further comprising a second register configured to store the double precision result from the accumulator from a prior arithmetic cycle.

5. The system of claim 1, further comprising means for storing the double precision result from the accumulator from a prior arithmetic cycle.

6. The system of claim 1, wherein the memory is configured to store double precision values according to even-odd memory address locations such that the high word is stored in an even memory address and the low word is stored in an odd memory address.

7. The system of claim 2, wherein the plurality of buffers are comprised of flip-flops configured to forward the data received from memory to at least one of the plurality of multiplexers.

8. The system of claim 1, wherein the memory structure is embodied in at least one of the following: an xDSL modem, central office (CO) equipment, a tuner board, a set-top box, a satellite system, a television, a computing device, a cellular telephone, and a wireless communication receiver.

9. A method for increasing throughput of arithmetic operations on double precision data by reducing the number of memory accesses comprising:
retrieving a double precision value from a memory, wherein the double precision value is comprised of a high word and a low word, wherein the double precision value is retrieved in a single memory access;
selecting a word within the double precision value, wherein the portion selected is a single precision value;
multiplying the word with a single precision operand to generate a single precision product;
adding, at an accumulator, the product to a double precision operand to produce a double precision result; and
forwarding the double precision result back to the memory for storage.

10. The method of claim 9, wherein forwarding the double precision result back to the memory for storage further comprises storing the double precision result into at least one temporary buffers for additional processing.

11. The method of claim 10, wherein storing the double precision result into at least one temporary buffers for additional processing further comprises forwarding the result from the at least one temporary buffer back to the accumulator to be added with a new product generated by multiplying a second double precision value retrieved from memory.

12. The method of claim 9, further comprising performing a weighting operation on the single precision product, wherein the weighting operation comprises:
performing a bit-wise shift right operation on the single precision product; and
performing a sign extension on the single precision product after a bit-shift right operation has been performed.

13. The method of claim 9, wherein multiplying and adding are performed according to two's complement encoding.

14. The method of claim 9, wherein forwarding the double precision value back to memory for storage further comprises rounding down values that exceed the maximum range for two's complement notation.

15. The method of claim 9, wherein at least a portion of the method is performed in at least one of the following: an xDSL modem, central office (CO) equipment, a tuner board, a set-top box, a satellite system, a television, a computing device, a cellular telephone, and a wireless communication receiver.

16. A method for increasing throughput of arithmetic operations in an adaptive filtering algorithm comprising:
retrieving a double precision filter coefficient from a memory, wherein the coefficient is comprised of a high word and a low word, wherein the double precision coefficient is retrieved in a single memory access;
selecting among the high word, the low word, and a single precision error correction factor;
multiplying the selection with a single precision data input to generate a single precision product;
adding the single precision product to a double precision value to generate a new double precision filter coefficient; and
forwarding the new coefficient back to memory for storage.

17. The method of claim 16, further comprising storing the double precision filter coefficient into at least one temporary buffer for further processing.

18. The method of claim 17, further comprising
adding the result from the at least one temporary buffer to a new product calculated utilizing a new double precision value retrieved from memory.

19. The method of claim 16, further comprising performing a weighting operation on the single precision product, wherein the weighting operation comprises:
performing a bit-wise shift right operation on the single precision product; and
performing a sign extension on the single precision product after a bit-shift right operation has been performed.

20. The method of claim 16, wherein multiplying and adding are performed according to two's complement encoding.

21. The method of claim 16, wherein forwarding the double precision value back to memory for storage further comprises rounding down values that exceed the maximum range for two's complement notation.

22. The method of claim 16, wherein at least a portion of the method is performed in at least one of the following: an xDSL modem, central office (CO) equipment, a tuner board, a set-top box, a satellite system, a television, a computing device, a cellular telephone, and a wireless communication receiver.
